(19) United States
(12) Patent Application Publication
(10) Pub. No.: US 2013/0176171 A1
(43) Pub. Date: Jul. 11, 2013

(54) GNSS SUPERBAND ASIC AND METHOD WITH SIMULTANEOUS MULTI-FREQUENCY DOWN CONVERSION

(71) Applicants: Mark R. Webber, Gilbert, AZ (US); Bradley P. Badke, Chandler, AZ (US); Walter J. Feller, Airdrie (CA); Steven R. Miller, Phoenix, AZ (US)

(72) Inventors: Mark R. Webber, Gilbert, AZ (US); Bradley P. Badke, Chandler, AZ (US); Walter J. Feller, Airdrie (CA); Steven R. Miller, Phoenix, AZ (US)

(21) Appl. No.: 13/545,813

(22) Filed: Jul. 10, 2012

Related U.S. Application Data
(63) Continuation-in-part of application No. 12/635,527, filed on Dec. 10, 2009, now Pat. No. 8,217,833.
(60) Provisional application No. 61/121,831, filed on Dec. 11, 2008.

(51) Int. Cl. G01S 19/37

(52) U.S. Cl. CPC G01S 19/37
USPC 342/357.76

(57) ABSTRACT

A multi-frequency down converter includes first and second signal paths. A common local oscillator/synthesizer drives both of the signal paths. Exemplary applications include GNSS systems operating across superbands. The down converter is adapted for use in a GNSS receiver system.

### CROSS-REFERENCE TO RELATED APPLICATIONS

This application is a continuation-in-part of and claims priority in U.S. patent application Ser. No. 12/635,527, filed Dec. 10, 2009, now U.S. Pat. No. 8,217,833, issued Jul. 10, 2012, U.S. Provisional Patent Application No. 61/121,831, filed Dec. 11, 2008, U.S. patent application Ser. No. 12/876,888, filed Sep. 7, 2010, and U.S. Provisional Patent Application No. 61/240,098, filed Sep. 4, 2009, which are incorporated herein by reference.

### BACKGROUND OF THE INVENTION

1. Field of the Invention

The present invention relates generally to global navigation satellite systems (GNSS) receiver technology, and in particular to an application-specific integrated circuit (ASIC) for down-converting dual frequency signals from a GNSS frequency superband simultaneously.

2. Description of the Related Art

Global navigation satellite systems (GNSS) include the Global Positioning System (GPS), which was established by the United States government and employs a constellation of 24 or more satellites in well-defined orbits at an altitude of approximately 26,500 km. These satellites continually transmit microwave L-band radio signals in three frequency bands, centered at 1575.42 MHz, 1227.60 MHz and 1176.45 MHz, denoted as L1, L2 and L5 respectively. All GNSS signals include timing patterns relative to the satellite's onboard precision clock (which is kept synchronized by a ground station) as well as a navigation message giving the precise orbital positions of the satellites. GPS receivers process the radio signals, computing ranges to the GPS satellites, and by triangulating these ranges, the GPS receiver determines its position and its internal clock error. Different levels of accuracies can be achieved depending on the techniques employed.

GNSS also includes Galileo (Europe), the GLObal NAvigation Satellite System (GLONASS, Russia), Beidou (China), Compass (proposed), the Indian Regional Navigational Satellite System (IRNSS) and QZSS (Japan, proposed). Galileo will transmit signals centered at 1575.42 MHz, denoted L1 or E1, 1176.45 denoted E5a, 1207.14 MHz, denoted E5b, 1191.795 MHz, denoted E5 and 1278.75 MHz, denoted E6. GLONASS transmits groups of FDM signals centered approximately at 1602 MHz and 1246 MHz, denoted GL1 and GL2 respectively. QZSS will transmit signals centered at L1, L2, L5 and E6. Groups of GNSS signals are herein grouped into “superbands”.

The United States' Global Positioning System (GPS) first reached Fully Operational Capability on Jul. 17, 1995. After almost two decades, advances in technology and new demands have prompted efforts to modernize the GPS system. Part of the modernization are new civilian navigation signals to be transmitted on a frequency other than the L1 frequency (1575.42 MHz). This signal became known as the L2C signal because it is a civilian signal broadcast on the L2 frequency (1227.6 MHz). It is transmitted by all block IIR-M and newer generation satellites.

To gain a better understanding of the accuracy levels achievable by using GNSS, it is necessary to understand the types of signals available from the GNSS satellites. One type of signal includes both the coarse acquisition (C/A) code, which modulates the L1 radio signal, and the precision (P) code, which modulates both the L1 and L2 radio signals. These are pseudorandom digital codes that provide a known pattern that can be compared to the receiver's version of that pattern. By measuring the time-shift required to align the pseudorandom digital codes, the GNSS receiver is able to compute an unambiguous pseudo-range to the satellite. Both the C/A and P codes have a relatively long “wavelength,” of about 300 meters (1 microsecond) and 30 meters ( 1/10 microsecond), respectively. Consequently, use of the C/A code and the P code yield position data only at a relatively coarse level of resolution.

The second type of signal utilized for position determination is the carrier signal. The term “carrier,” as used herein, refers to the dominant spectral component which remains in the radio signal after the spectral content caused by the modulated pseudorandom digital codes (C/A and P) is removed. The L1 and L2 carrier signals have wavelengths of about 19 and 24 centimeters, respectively. The GNSS receiver is able to “track” these carrier signals, and in doing so, make measurements of the carrier phase to a small fraction of a complete wavelength, permitting range measurement to an accuracy of less than a centimeter.

In stand-alone GNSS systems that determine a receiver's position coordinates without reference to a nearby reference receiver, the process of position determination is subject to errors from a number of sources. These include errors in the satellite's clock reference, the location of the orbiting satellite, ionospheric-induced propagation delay errors, and tropospheric refraction errors. A more detailed discussion of these sources of error is provided in U.S. Pat. No. 5,828,336 by Yunck, et al.

To overcome the errors of stand-alone GNSS, many kinematic positioning applications make use of multiple GNSS receivers. A reference receiver located at a reference site having known coordinates receives the satellite signals simultaneously with the receipt of signals by a remote receiver. Depending on the separation distance, many of the errors mentioned above will affect the satellite signals equally for the two receivers. By taking the difference between signals received both at the reference site and at the remote location, these errors are effectively eliminated. This facilitates an accurate determination of the remote receiver's coordinates relative to the reference receiver's coordinates. The technique of differencing signals is known in the art as differential GNSS (DGNSS). The combination of DGNSS with precise measurements of carrier phase leads to position accuracies of less than one centimeter root-mean-squared (centimeter-level positioning). When DGNSS positioning utilizing carrier phase is done in real-time while the remote receiver is potentially in motion, it is often referred to as Real-Time Kinematic (RTK) positioning.

One of the difficulties in performing RTK positioning using carrier signals is the existence of an inherent ambiguity that arises because each cycle of the carrier signal looks exactly alike. Therefore, a range measurement based upon carrier phase has an ambiguity equivalent to an integral number of carrier signal wavelengths. Various techniques are used to resolve the ambiguity, often with some form of double-differencing. The prior art related to this includes U.S. Pat. No. 4,170,776 by MacDoran, U.S. Pat. No. 4,667,203 by Counselman, U.S. Pat. No. 4,963,889 by Hatch, U.S. Pat. No. 5,296,861 by Knight, and U.S. Pat. No. 5,519,620 by Talbot et al. Once ambiguities are solved, however, the receiver continues to apply a constant ambiguity correction to a carrier measurement until loss of lock on that carrier signal. Regardless of the technique employed, the problem of solving integer ambiguities, in real-time, is always faster and more robust if there are more measurements upon which to discriminate the true integer ambiguities. Robust means that there is less chance of choosing an incorrect set of ambiguities. The degree to which the carrier measurements collectively agree to a common location of the GNSS receiver is used as a discriminator in choosing the correct set of ambiguities. The more carrier phase measurements that are available, the more likely it is that the best measure of agreement will correspond to the true (relative to the reference GNSS) position of the remote GNSS receiver.

One method, which effectively gives more measurements, is to use dual frequency (DF) receivers for tracking delta-range measurements from P code modulation on the L1 and L2 carriers simultaneously with the L1 C/A code generating code phase measurements. The L1 and L2 carriers are modulated with codes that leave the GNSS satellite at the same time. Since the ionosphere produces different delays for radio carriers of different frequencies, such dual frequency receivers can be used to obtain real-time measurements of ionospheric delays at various receiver positions. The L1 and L2 ranging measurements are combined to create a new L1 ranging measurement that has an ionospheric delay of the same sign as the ionosphere delay in the L1 pseudorange. Accurate ionospheric delay information, when used in a position solution, can help produce more accuracy. Absent such real-time ionospheric delay measurements, other correction techniques are commonly used, such as differential GNSS (DGNSS), proprietary third party satellite augmentation system (SAS) services available on a paid subscription basis, or the U.S.-sponsored Wide Area Augmentation System (WAAS).

As compared to single-frequency (typically L1) receiver systems, previous dual-frequency receiver systems have tended to be relatively expensive because of their additional components for accommodating L2 measurements. Moreover, the additional components tended to consume more power and required additional space. Still further, dual-frequency receivers should be adaptable for use with all present and projected GNSS, transmitting signals which can be grouped into two “superbands” of radio signal frequencies generally in the range of about 1160 MHz to 1250 MHz and 1525 MHz to 1613 MHz. Accordingly, a preferred multi-frequency receiver should be: a single, application-specific integrated circuit (ASIC); programmable for down converting various pairs of frequencies; minimally-sized; and capable of operating with minimal power.

### SUMMARY OF THE INVENTION

In the practice of an aspect of the present invention, a multi-frequency down conversion ASIC is provided in a GNSS receiver system. The receiver system can include an active antenna inputting amplified GNSS signals to the down converter ASIC, which outputs digital signals to a correlator ASIC, which in turn provides digital signals to a GNSS solution processor. The down converter ASIC has dual frequency channels driven by a common local oscillator/synthesizer (LO/Synth) and synchronized ADC clocks. External matching and filtering components, including bandpass filters, maximize performance and accommodate frequencies in the superband for compatibility with all GNSS.

### BRIEF DESCRIPTION OF THE DRAWINGS

FIG. 1 is a block diagram of a multi-frequency GNSS receiver system embodying an aspect of the present invention.

FIG. 2 is schematic diagram of a down converter of the GNSS receiver system, shown configured for GPS L1/L2.

FIG. 3 is a schematic diagram of the down converter application specific integrated circuit (ASIC).

FIG. 4 is a schematic diagram of an alternative embodiment of the present invention, shown configured for GPS-L1/GPS-L5.

FIG. 5 is a schematic diagram of an alternative embodiment of the present invention, shown configured for GPS-L1/GLONASS-L1.

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Said terminology will include the words specifically mentioned, derivatives thereof and words of similar meaning.

Global navigation satellite systems (GNSS) are broadly defined to include the Global Positioning System (GPS, U.S.), Galileo (proposed, Europe), GLONASS (Russia), Beidou (China), Compass (proposed), the Indian Regional Navigational Satellite System (IRNSS), QZSS (Japan, proposed) and other current and future positioning technology using signals from satellites, with or without augmentation from terrestrial sources.

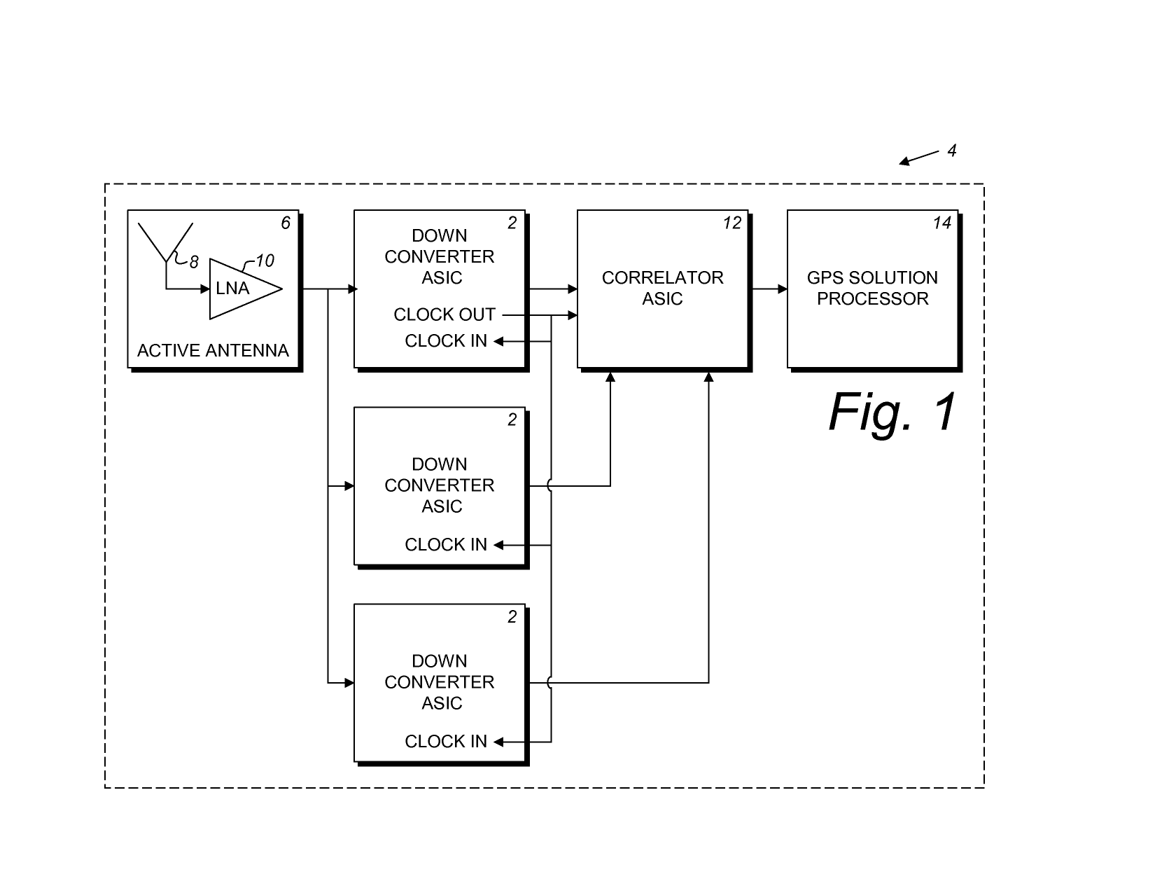

The following table provides an example of GNSS frequency channel allocations, which could be implemented with the application specific integrated circuit (ASIC) down converter 2 as shown in FIG. 1:

TABLE 1
System Center Frequencies and Bandwidth Requirements

| | | F_{center} | Bandwidth |
|---|---|---|---|
| Superband | System (signal) | (MHz) | (MHz) |
| 1 | SBAS | 1542 | 34 |
| 1 | GPS (L1CA) | 1575.42 | 24.0 |
| 1 | GPS (L1C) | 1575.42 | 24.0 |
| 1 | GPS (L1P) | 1575.42 | 24.0 |
| 1 | GLONASS (L1) | 1602.0 | 16 |
| 1 | Galileo (E1) | 1575.42 | 24.0 |
| 2 | GPS (L2P) | 1227.6 | 24.0 |
| 2 | GPS (L2C) | 1227.6 | 24.0 |
| 2 | GPS (L5) | 1176.45 | 24.0 |
| 2 | GLONASS (L2) | 1246.0 | 16 |
| 2 | Galileo (E5a) | 1176.45 | 24.0 |
| 2 | Galileo (E5b) | 1207.14 | 24.0 |
| 2 | Galileo (E5ab) | 1191.795 | 51.15 |

### II. GNSS Superband ASIC with Multi-Frequency Down Conversion

Referring to FIG. 1 of the drawings in more detail, the reference numeral 2 generally designates an ASIC with multi-frequency down conversion embodying an aspect of the present invention. Without limitation on the generality of useful applications of the ASIC, a multi-frequency (e.g., dual-frequency) GNSS receiver system designated 4 is shown in FIG. 1 as an example of an application in which the present invention can be utilized. Such GNSS receiver systems can be employed in a wide range of useful applications, such as navigation, guidance and machine control in various industries, including precision farming, crop dusting, marine navigation, shipping, transportation, mining and manufacturing.

The receiver system 4 includes an antenna subsystem 6, which can comprise a passive antenna 8 connected to a low noise amplifier (LNA) 10. Active antennas may be tuned to specific GNSS frequencies, such as L1, L2, L5, etc. or tuned to accommodate superbands for multi-GNSS applications. The antenna subsystem 6 produces GNSS signals, which are input to one or more ASICs 2. The output of the ASIC 2 is received by an ASIC correlator 12, which can include a pseudo-range engine, and which provides input to a GNSS solution processor 14. The solution processor 14 can be connected to other components, such as graphical user interfaces (GUIs), autosteering, etc. Still further, satellite augmentation systems (SASs) of various types, including free services such as the Wide Area Augmentation System (WAAS) and Omnistar (paid subscription service) can be used for enhancing the accuracy of the system 4 by providing GNSS corrections.

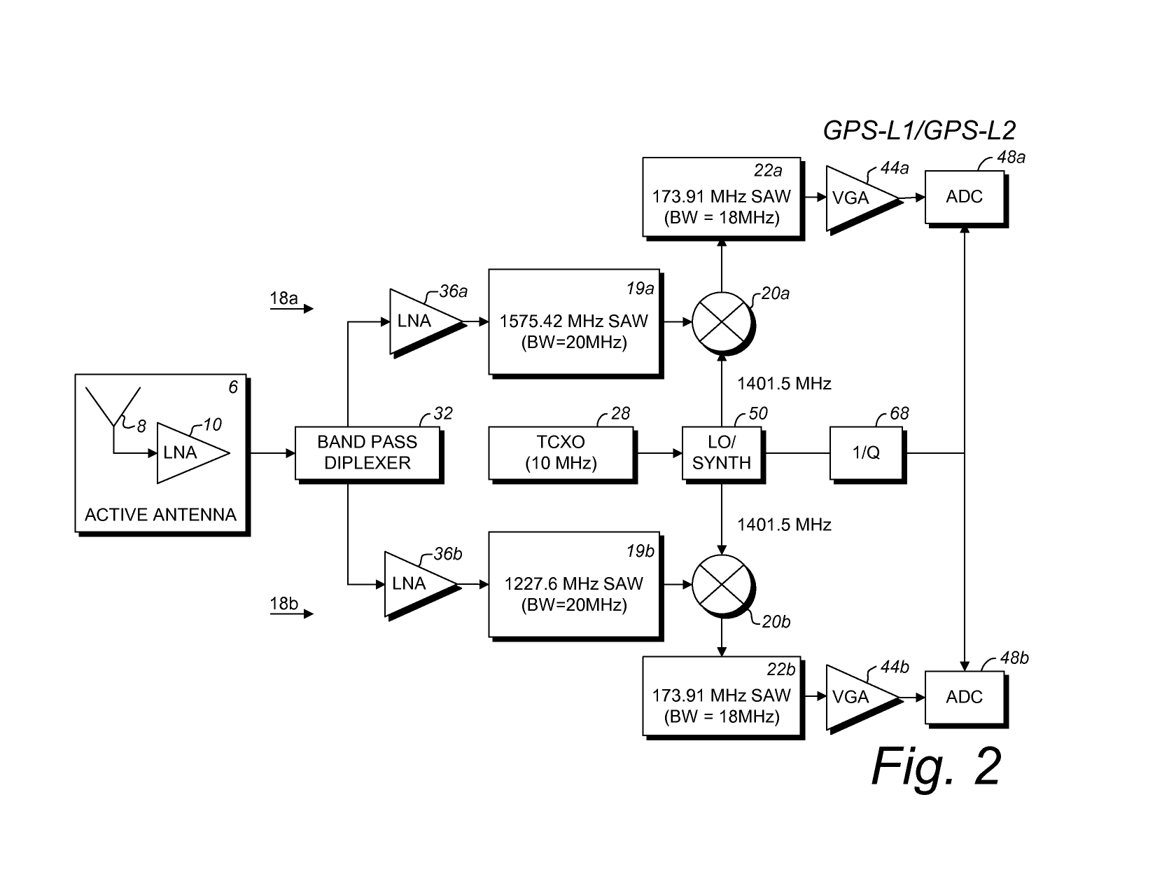

FIG. 2 shows a diagram of the ASIC 2 down converting GPS L1 and L2 ranging signals, representing a possible use of the present invention. The signals are received from the LNA 10 and divided by a band pass diplexer 32 (or a multiplexer for accommodating more than 2 GNSS signal ranges) for proceeding along separate signal paths 18a, corresponding to L1 centered at 1575.42 MHz, and 18b, corresponding to L2 centered at 1227.60 MHz. First stage surface acoustic wave (SAW) filters 19a,b have bandwidths of 20 MHz, for example, and are centered at these frequencies. The SAW filter outputs are received by respective high side and low side mixers 20a,b, which provide output to second stage SAW filters 22a,b with bandwidths of 18 MHz, for example, and are centered at 173.91 MHz. Variable gain amplifiers (VGAs) 44a,b receive the output from the second stage SAW filters 22a,b and are connected to analog-to-digital converters (ADCs) 48a,b. The signal paths 18a,b share a common synthesizer providing a common local oscillator signal (collectively LO/Synth 50) to low side and high side mixers 20a,b at 1401.5 MHz. LO/Synth 50 is also connected to a temperature compensated crystal oscillator (TCXO) 28 (10 MHz). The LO/Synth 50 provides an input to the Divide by Q (1/Q) divider 68 which provides the sample clock input to the ADCs 48a,b.

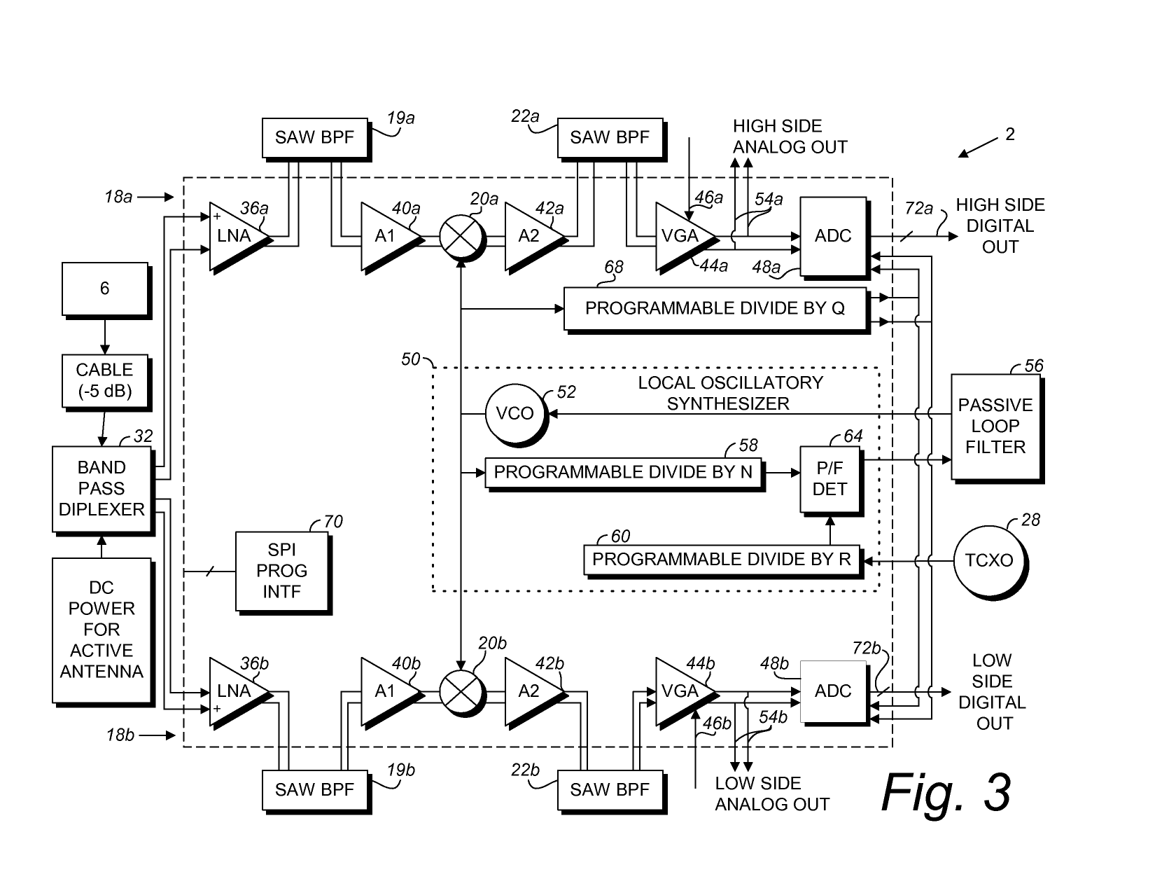

FIG. 3 shows the general IC configuration of the ASIC 2, configured for operation as a down converter with input from an active antenna 6 with a gain of, for example, +30 dB, which is connected to a band pass diplexer 32 providing GNSS signals for processing via respective signal paths 18a,b, including LNAs 36a,b connected to the diplexer 32 and to the first stage SAW band pass filters 19a,b, which are preferably external to the ASIC 2. RF amplifiers 40a,b (A1) receive signals from the SAW band pass filters 19a,b respectively and are connected to the mixers 20a,b, which are connected to intermediate frequency (IF) amplifiers 42a,b (A2). The second stage band pass filters 22a,b receive signals from the IF amplifiers 42a,b and provide signal inputs to variable gain amplifiers (VGAs) 44a,b, which are connected to and controlled by automatic gain control (AGC) signals 46a,b. The variable gain amplifiers 44a,b provide signal inputs to the analog-to-digital converters (ADCs) 48a,b, which respectively provide the digital outputs 72a,b from the high and low sides of the ASIC 2 corresponding to the high and low signal paths 18a,b. The variable gain amplifiers 44a,b also provide analog outputs 54a,b from the high and low sides of the ASIC 2 corresponding to the high and low signal paths 18a,b.

### III. LO/Synth 50

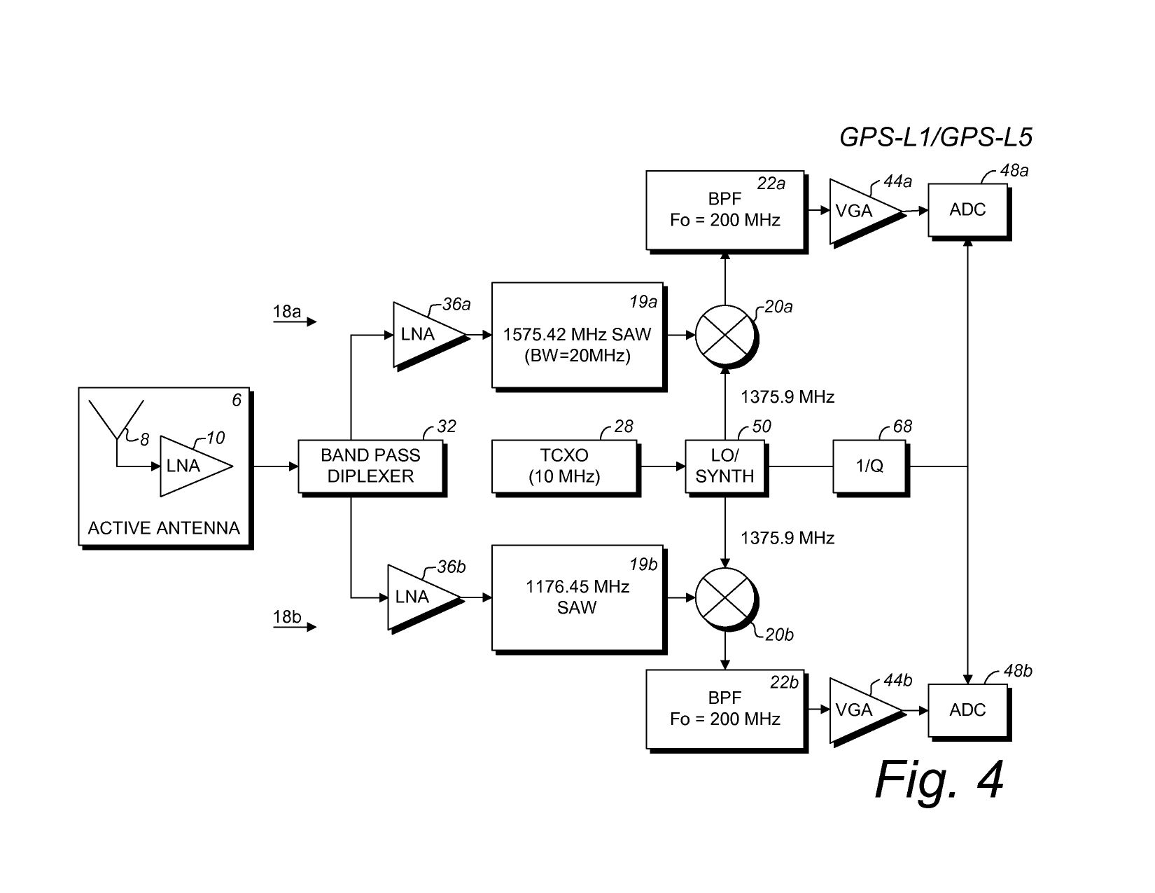

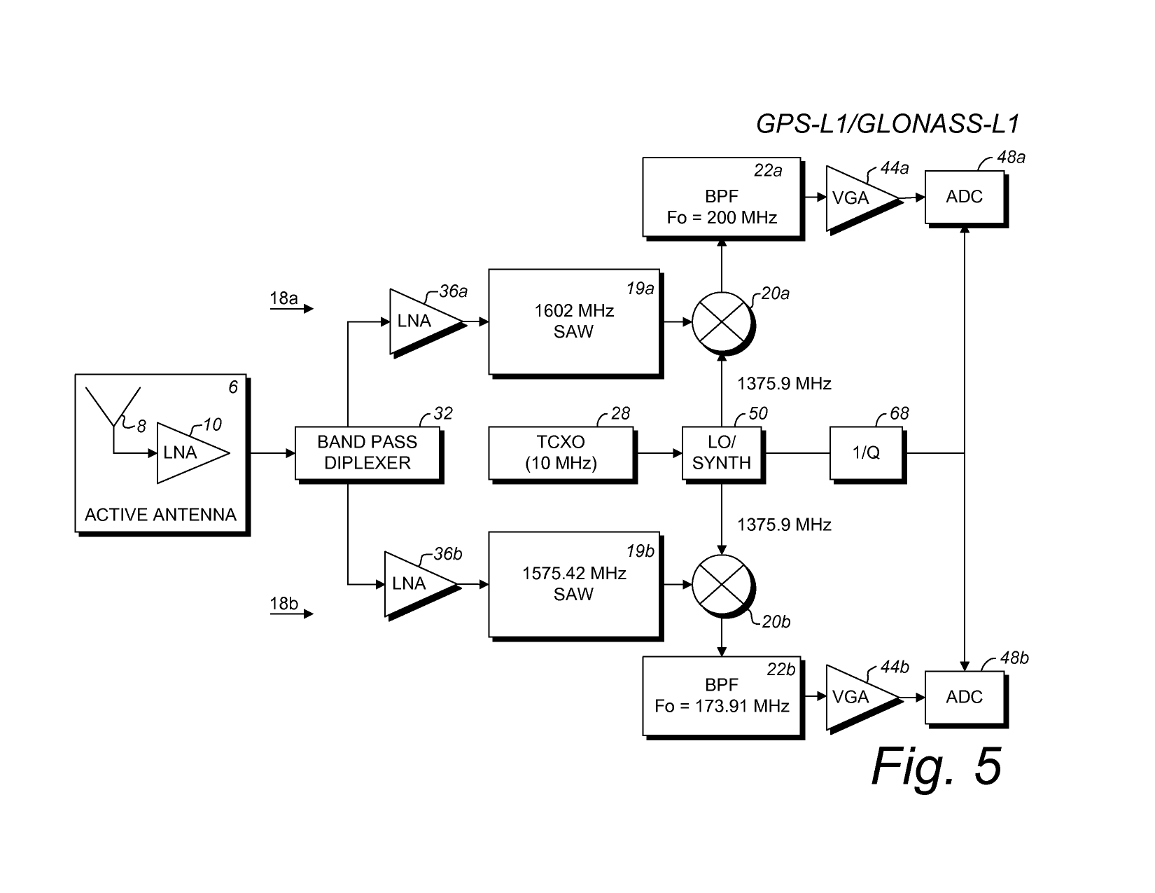

A common local oscillator/synthesizer (LO/Synth) 50 drives both signal paths 18a,b. The LO/Synth 50 can comprise a synthesizer including a voltage controlled oscillator (VCO) 52 connected to the mixers 20a,b and an external passive loop filter 56. The LO/Synth 50 also includes a Programmable Divide by N (1/N) 58 connected to the VCO 52 and the phase/frequency detector 64. The LO/Synth 50 also includes a Programmable Divide by R (1/R) 60 which is connected to a phase/frequency detector (P/F Det) 64, which receives signals from the external temperature controlled crystal oscillator (TCXO) 28. The analog to digital clock divider Programmable Divide by Q (1/Q) 68 is connected to the mixers 20a,b and to the analog-to-digital converters (ADCs) 48a,b. A serial peripheral programming interface (SPI) 70 is provided for interfacing with external devices whereby the operation of the down converter 2 can be externally controlled by preprogramming such variables as “divide by” values, on/off switching and other components controls. Moreover, the external band pass filters 19a,b and 22a,b enable a relatively “universal” down converter 2 to be utilized in various receiver systems accommodating a wide range of current and future GNSSs. Such receiver systems 4 can include multiple band pass filters and other components external to the ASIC 2 whereby the system can be switched among various filter combinations for multi-frequency operation. Such switching can occur automatically, e.g., via software operation selecting the best available satellite constellations, or manually by an operator based on current satellite availability. Respective high and low side digital outputs 72a,b provide output “words,” which can comprise 4 bit digital signals output from the ADCs 48a,b. Respective high and low side analog outputs 54a,b, provide analog outputs which can be connected to external analog to digital converters that provide higher bit resolution for example, than the on-chip analog to digital converters ADCs 48a,b. The ASIC 2 in the GNSS receiver system 4 provides a number of features and accommodates a number of functions, which include the following:
The system 4 simultaneously down converts two RF channels to a first, analog IF frequency.
The system 4 uses external matching components for the RF input to permit operation at either superband.
Signals in each RF signal path 18a,b are differential allowing common mode rejection of interfering signals.
The phase noise of the LO/Synth 50 can be extremely low and the LNAs 36a,b and RF amplifiers 40a,b have higher bias points and linearity than many commercially available devices.
The system 4 provides two analog-to-digital converters and the required ADC sample clock to support IF sub-sampling of both analog IF signals.
Each system 4 has synchronization means to permit placing multiple devices in a receiver to down convert multiple pairs of signals in two superbands.
Each system 4 has RF signal path bandwidths wide enough such that each path 18a,b may convert all or part of a super band of frequencies to a lower IF frequency and digitize them in the ADCs 48a,b. For example, signal path 18a could down convert GPS L1 and GLONASS L1 signals while signal path 18b could down convert GPS L2 and GLONASS L2 signals.
The ADC sample clock is generated by dividing the down converter synthesizer (LO/Synth) 50 output frequency by an integer. This requires less power and is less prone to self-interference than adding a second synthesizer to generate the ADC sample clock. This also avoids low frequency beat notes being generated between the VCO 52 and the ADC clock. Low frequency beat notes would greatly increase the amount of power supply decoupling required.
This sample clock can be provided to other DCAs 2 in order to synchronize the ADC sampling clocks of all signals being down-converted.
All band limiting filters can be located off-chip. Off-chip filters and a relatively high first IF frequency allow the use of wider band filters for improved multipath mitigation and high end performance superior to typical commercially available devices.
The noise bandwidth of the system 4 is set by the band pass filters 22a,b in the first IF. This filter may be external to the ASIC 2 or a switchable filter internal to the ASIC 2. The switchable filter could be narrower than the external filter and used in weak signal or interference situations.
The synthesizer passive loop filter 56 is off-chip, allowing flexibility in choosing a synthesizer PLL loop bandwidth. The Synthesizer VCO 52 tunable resonant circuit is on-chip reducing noise and interference problems associated with transporting the resonator signals over bond wires to and from the ASIC 2 die.
The system 4 uses the temperature compensated crystal oscillator (TCXO) 28 for generating its own reference signal, as opposed to less accurate crystals.
All frequency dividers in the system 4 are programmable via the SPI 70.
The synthesizer LO/Synth 50 frequency can be programmed to a large number of different frequencies. It is not constrained to be a fixed ratio of the reference frequency. There is a frequency divider provided for the reference signal.
Portions of the system 4 can be selectively (via the SPI 70) turned on/off to save power. For example, portions of the ASIC 2 corresponding to one of the signal paths 18a,b can be turned off
The system 4 outputs are configurable to be 4 bit linear output or 2 bit Lloyd-Max output format. 4 bit outputs allow interference mitigation techniques to be implemented and provide lower C/No implementation loss than 2 bit converters used in commercially available devices.
The system 4 can accept clock (sampling) signals from an internal or an external sample clock. A common or an external sample clock can enable multiple ASICs to use the same sample clock to sample multiple (super) bands of GNSS signals (FIG. 1).
The internally generated ADC sample clock has very low jitter allowing 9 bit ENOB performance from external analog-to-digital converters.
The ADCs 48a,b have low inherent aperature jitter allowing digital sub-sampling techniques to be employed resulting in lower ADC clock frequency requirements.
The system 4 provides high channel to channel isolation so that interference in one channel does not interfere with operation of the other channel.
The system 4 is capable of down converting two signals from the same superband (e.g., GPS-L1/GPS-L5 (FIG. 4), GPS-L1/GLONASS-L1 (FIG. 5), etc.).

FIG. 4 is a schematic diagram of an alternative embodiment of the present invention, shown configured for GPS-L1/GPS-L5. The SAW BPF 19b, 22a, 22b frequencies are changed accordingly. Advantageously, the same SAW BPF 19a (1575.42 MHz) can be used for GPS-L1/GPS-L2 (FIG. 2) and GPS-L1/GPS-L5 (FIG. 4). FIG. 5 is a schematic diagram of another alternative embodiment of the present invention, shown configured for GPS-L1/GLONASS-L1. The frequencies of the SAW BPFs 19a, 19b, 22a, 22b and the LO/Synth 50 are changed accordingly. Because the SAW BPFs are external components, the same ASIC 2 as described above can be used for these and other alternative embodiment systems. Of course, other GNSS superband signal pairs can also be accommodated by the ASIC 2 by reconfiguring the external component SAW BPFs.

It is to be understood that the invention can be embodied in various forms, and is not to be limited to the examples discussed above. Other components and configurations can be utilized in the practice of the present invention.

Having thus described the invention, what is claimed as new and desired to be secured by Letters Patent is:

1. A method of simultaneously down-diverting global navigation satellite system (GNSS) signals in multiple frequency bands, which method comprises the steps of:
providing an integrated circuit (IC) with multiple signal paths;
receiving GNSS signals corresponding to said frequency bands;
providing a common local oscillator/synthesizer (LO/Synth);
driving each of said signal paths with said LO/Synth;
receiving in said signal paths GNSS signals corresponding to said frequency bands associated with said signal paths respectively;
providing said LO/Synth with a common programmable divider;
simultaneously down-converting said signals to lower intermediate frequencies (IF) with said programmable divider;
providing a multiplexer with multiple out puts and located externally to said IC;
connecting each said signal path to and receiving input from said multiplexer;
providing multiple analog-to-digital converters (ADCs) and connecting each to said programmable divider;
each said ADC receiving a down-converted signal as an input and providing a digital signal as an output;
providing multiple low-noise amplifiers (LNAs) in said signal paths;
electrically connecting each said LNA to a respective multiplexer output;
providing first and second band pass filters located externally to said IC; and
connecting each said BPF to a respective LNA.

2. The method of claim 1 wherein each said signal frequency band comprises a superband of frequencies associated with multiple GNSSs.

3. The method of claim 2, which includes the additional steps of:
providing multiple mixers;
electrically connecting each said mixer to said LO/Synth in a respective signal path; and
connecting each said mixer to a respective BPF.
